(19) United States
(12) Patent Application Publication
(10) Pub. No.: US 2020/0364795 A1
(43) Pub. Date: Nov. 19, 2020

(54) VALUE CHAIN EXTRACTION DEVICE AND VALUE CHAIN EXTRACTION METHOD USING THE SAME

(71) Applicant: KOREA ELECTRONIC TAXATION SYSTEM ASSOCIATION, Seoul (KR)

(72) Inventors: Tae Uk AHN, Seoul (KR); Wian Tai PAIK, Anyang-si, Gyeonggi-do (KR)

(21) Appl. No.: 16/768,458

(22) PCT Filed: Nov. 29, 2018
(86) PCT No.: PCT/KR2018/014892

§ 371 Date: May 29, 2020

(30) Foreign Application Priority Data
Nov. 30, 2017 (KR) 10-2017-0163644

(51) Int. Cl. G06Q 40/06; G06Q 30/02

(52) U.S. Cl. CPC G06Q 40/06; G06Q 30/0201

(57) ABSTRACT

Provided are a value chain extraction device and a value chain extraction method using the same. The value chain extraction device of the present disclosure includes: a communication unit transmitting and receiving data on the presence or absence of a trade with an external second server and transmitting and receiving data on trade details with an external third server; and a controller electrically connected to the communication unit and extracting a value chain company list from the data on the presence or absence of the trade and the data on the trade details, wherein the communication unit transmits the value chain company list to an external terminal in a case where the controller extracts the value chain company list.

### TECHNICAL FIELD

The present disclosure relates to a value chain extraction device and a value chain extraction method using the same.

### BACKGROUND ART

Conventional risk management of a trade partner may be based only on information on finance-related events, such as overdue trades or default trades. However, it is common to rely on the intuition of an individual, such as an expert, for an overall market situation, such as estimation for a decline in sales of the trade partner or a company in the same kind of industry.

Relying on the intuition of an individual, such as an expert, may lead to a risk in the risk management of the trade partner. In addition, the risk management of the trade partner based only on financial health of the trade partner may have a limitation in a complex network market.

### DISCLOSURE

### Technical Problem

An object of the present disclosure is to solve the above and other problems.

Another object is to extract an entity that may affect a company by having financial close relevance to a trade partner of the company.

### Technical Solution

According to an aspect of the present disclosure, there is provided a value chain extraction device including: a communication unit transmitting and receiving data on the presence or absence of a trade with an external second server and transmitting and receiving data on trade details with an external third server; and a controller electrically connected to the communication unit and extracting a value chain company list from the data on the presence or absence of the trade and the data on the trade details, wherein the communication unit transmits the value chain company list to an external terminal in a case where the controller extracts the value chain company list.

According to another aspect of the present disclosure, there is provided a value chain extraction method using a value chain extraction device including a communication unit and a controller, the value chain extraction method including: receiving a request to extract a value chain based on a master node from an external terminal; extracting a candidate node relevant to the master node by the controller in a case where the communication unit receives data on the presence or absence of a trade of the master node from an external second server; extracting an input factor group relevant to the candidate node by the controller in a case where the communication unit receives data on trade details of the candidate node from an external third server; extracting relevance data of the candidate node from the input factor group of the candidate node by the controller; and extracting a sub-node from the candidate node based on the relevance data of the candidate node by the controller.

### Advantageous Effects

According to at least one of the embodiments of the present disclosure, it is possible to extract the entity that may affect the company by having financial close relevance to the trade partner of the company.

Further scope of applicability of the present disclosure will become apparent from the detailed description below. However, various changes and modifications within the spirit and scope of the present disclosure may be clearly understood by those skilled in the art. Therefore, it should be understood that certain embodiments, such as the detailed description and preferred embodiments of the present disclosure, are only given by way of illustration.

### DESCRIPTION OF DRAWINGS

FIG. 1 is a diagram showing an example of a value chain according to the present disclosure.

FIGS. 2A and 2B are examples of a decision tree according to the present disclosure.

FIG. 3 is a flow chart showing a value chain generation method according to the present disclosure.

FIG. 4 is a diagram showing an example of a value chain according to the present disclosure.

FIG. 5 is a schematic diagram of a value chain extraction device according to an embodiment of the present disclosure.

FIGS. 6 to 10 are flow charts of a value chain extraction method according to an embodiment of the present disclosure.

FIG. 11 is a diagram showing a value chain company list in which sub-nodes derived by a value chain extraction method according to an embodiment of the present disclosure are listed based on relevance.

FIG. 12 is a diagram illustrating a graph visualizing a correlation between nodes derived by a value chain extraction method according to an embodiment of the present disclosure.

### BEST MODE

Hereinafter, embodiments of the present disclosure will be described in detail with reference to the accompanying drawings. The same or similar components will be denoted by the same reference numerals independent of the drawing numerals, and an overlapping description for the same or similar components will be omitted. The terms “module” and “unit” for components used in the following description are used only to easily describe the disclosure. Therefore, these terms do not have meanings or roles that distinguish from each other in themselves. Further, in a case where it is decided that a detailed description for the known art related to the present disclosure may obscure the gist of the present disclosure, the detailed description will be omitted. Furthermore, it should be understood that the accompanying drawings are provided only in order to allow the embodiments of the present disclosure to be easily understood, and the spirit of the present disclosure is not limited by the accompanying drawings, but includes all the modifications, equivalents, and substitutions included in the spirit and the scope of the present disclosure.

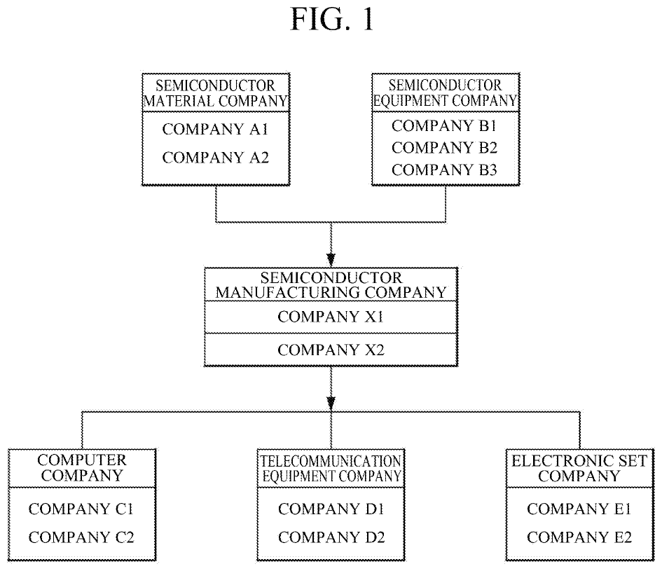

FIG. 1 is a diagram showing an example of a value chain according to the present disclosure. Referring to FIG. 1, the value chain appears based on a semiconductor manufacturing company. A node which is a center of the value chain may be referred to as a master node. For example, the master node in the value chain of FIG. 1 may be the semiconductor manufacturing company, i.e. company X1 or company X2. For another example, the master node in the value chain of FIG. 1 may be a company handling a semiconductor material, i.e. company A1 or company A2.

An arrow shown in FIG. 1 may be referred to as a direction of delivery. For example, the semiconductor manufacturing company may receive the semiconductor material and semiconductor equipment. For example, the semiconductor manufacturing company may deliver a semiconductor to a computer company, a telecommunication equipment company and an electronic set company.

The semiconductor manufacturing company may be referred to as a financial debtor to companies A1, A2, B1, B2 and B3. The semiconductor manufacturing company may be referred to as a financial creditor to companies C1, C2, D1, D2, E1 and E2. In a case where financial health of companies C1, C2, D1, D2, E1 and E2 is deteriorated, financial health of the semiconductor manufacturing company may be deteriorated. In a case where the financial health of the semiconductor manufacturing company is deteriorated, it may have negative effects on financial health of companies A1, A2, B1, B2 and B3.

The financial health of companies C1, C2, D1, D2, E1 and E2 may affect the semiconductor manufacturing company differently. For example, in a case where company C1 has a high share of a computer market and trades a relatively large volume with company X1, deteriorated financial health of company C1 may have a relatively large risk for company X1.

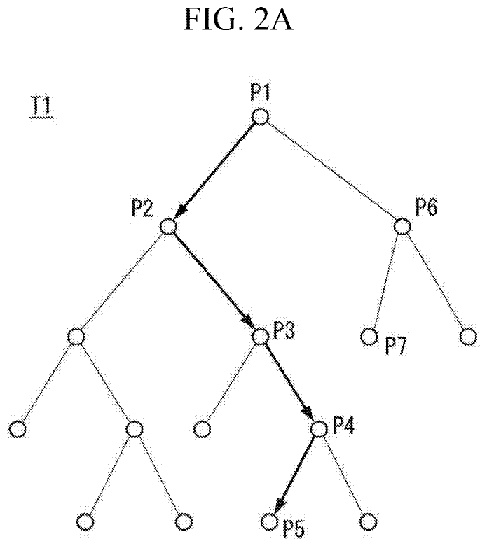

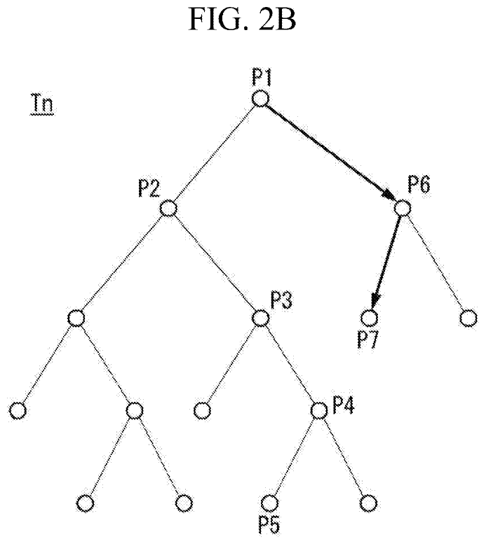

FIGS. 2A and 2B are examples of a decision tree according to the present disclosure.

The decision tree shown in FIGS. 2A and 2B may be used to calculate a probability to be included in the value chain based on trade characteristics of each company. A first tree T1 shown in FIG. 2A may have the same structure as an nth tree Tn shown in FIG. 2B. However, the first tree T1 and the nth tree Tn may have different paths from each other. The decision trees T1 and Tn may return different values based on the path. In FIGS. 2A and 2B, each decision path may be indicated by a bold arrow line.

Each decision tree shown in FIGS. 2A and 2B may be referred to as a kind of ‘random forest’. The random forest may be an ensemble technique to randomly learn a plurality of decision trees. The random forest may include a learning process of forming the plurality of decision trees and a test process of taking an input sample to classify and predict it.

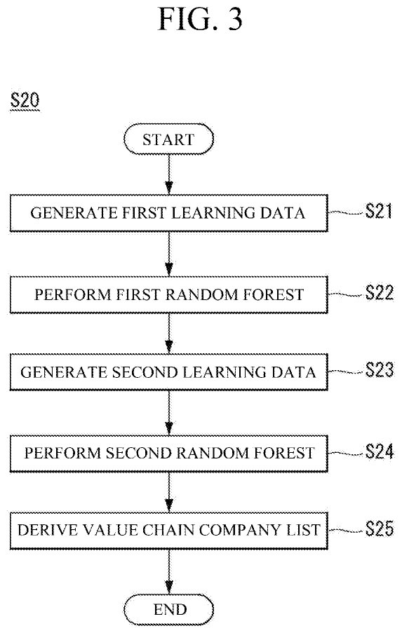

FIG. 3 is a flow chart showing a value chain generation method according to the present disclosure.

Referring to FIG. 3, a value chain generation method (S20) may include generating first learning data (S21). In this operation (S21), it is possible to build information on whether trade partners of a company to be analyzed belong to a value chain of a corresponding industry.

The value chain generation method (S20) may include performing a first random forest (S22). In this operation (S22), first learning data may have a posterior probability value by a first random forest method.

The value chain generation method (S20) may include generating second learning data (S23). In this operation (S23), second learning data may be formed based on the posterior probability value by adding or deleting a new company based on the first learning data.

The value chain generation method (S20) may include performing a second random forest (S24). In this operation (S24), the second learning data may have the posterior probability value.

The value chain generation method (S20) may include deriving a value chain company list (S25). In this operation (S25), the second learning data may be sorted based on the posterior probability value. Alternatively, in this operation (S25), the second learning data may be arranged based on the posterior probability value.

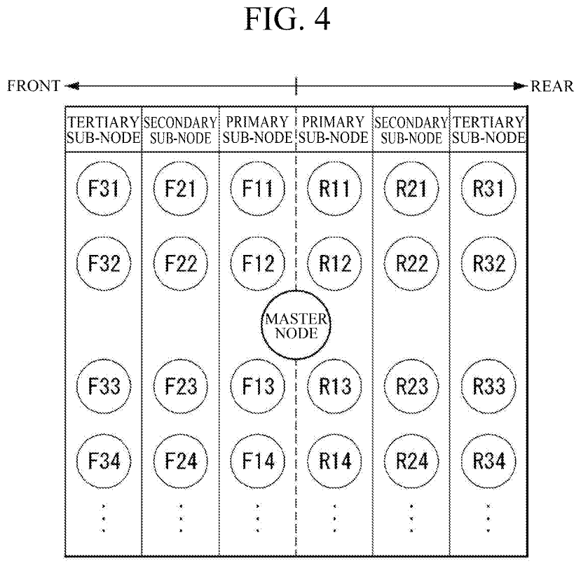

FIG. 4 is a diagram showing an example of a value chain according to the present disclosure. The value chain may be divided into a front and a rear based on the master node.

A node relevant to the master node may be referred to as a sub-node. A front sub-node may be a sub-node positioned in front of the master node. A rear sub-node may be a sub-node positioned in rear of the master node. The rear sub-node may be a company that delivers (supplies) a product to the master node. The front sub-node may be a company that purchases a product from the master node.

The sub-nodes may be classified into primary, secondary, and tertiary sub-nodes based on a degree of connection with the master node. For example, the primary sub-node F11, F12, F13, F14, R11, R12, R13 or R14 may be a company in direct trade with the master node. For example, the secondary sub-node R21, R22, R23, R24, F21, F22, F23 or F24 may be a company connected to the master node through the primary sub-node F11, F12, F13, F14, R11, R12, R13 or R14.

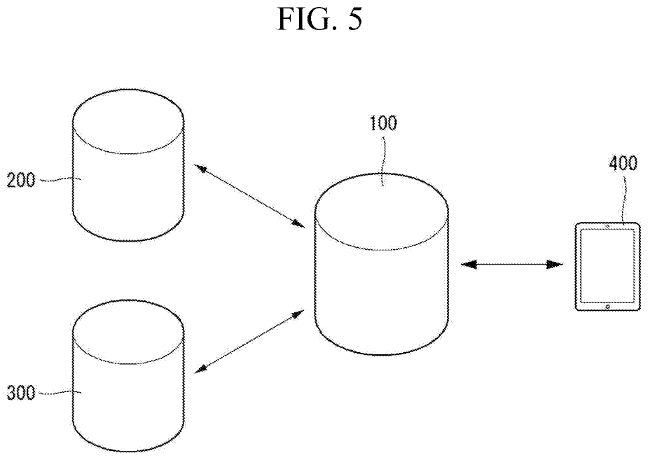

FIG. 5 is a schematic diagram of a value chain extraction device according to an embodiment of the present disclosure.

Referring to FIG. 5, a first server 100 may be the value chain extraction device according to an embodiment of the present disclosure.

The first server 100 may be a server that builds modeling to extract the value chain. The first server 100 may be connected to a second server 200 and/or a third server 300 in a wired and/or wireless manner. The first server 100 may include a controller. The first server 100 may include a communication unit which may communicate with the outside.

The second server 200 may hold and manage information on the presence or absence of a trade of a specific company. For example, the second server 200 may hold and manage information on a bank, a credit rating company, a company trade information distribution company, an investment financial company, etc. The communication unit of the first server 100 may communicate with the second server 200 to transmit and receive data.

The third server 300 may hold and manage information on trade details of the specific company. For example, the third server 300 may hold and manage information on the National Tax Service and/or the Statistics Office. For another example, the third server 300 may be integrated with the second server 200. The communication unit of the first server 100 may communicate with the third server 300 to transmit and receive data.

A terminal 400 may be connected to the first server 100 in a wired and/or wireless manner. The terminal 400 may be a computer or a mobile terminal. For example, the terminal 400 may communicate with the first server 100 through an application. The communication unit of the first server 100 may communicate with the terminal 400 to transmit and receive data.

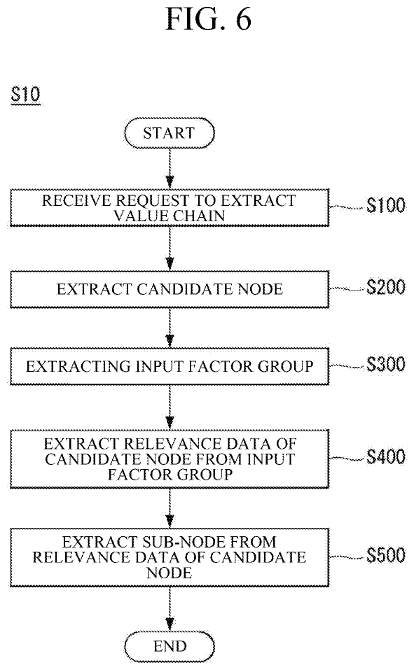

FIGS. 6 to 10 are flow charts of a value chain extraction method according to an embodiment of the present disclosure. FIGS. 6 to 10 may be described in connection with FIG. 5.

Referring to FIG. 6, a value chain extraction method (S10) according to an embodiment of the present disclosure may include receiving a request to extract a value chain (S100). The terminal 400 may request the first server 100 to extract the value chain. In this operation (S100), the first server 100 may receive the request to extract the value chain from the terminal 400.

The value chain may be extracted based on the master node. For example, the master node may a specific company. That is, to extract the value chain based on the master node may be to extract a network financially relevant to a specific company. A candidate node may be a company or entity financially relevant to the master node. A sub-node may be a company or entity financially relevant to the master node at a certain level or more among the candidate nodes.

The value chain extraction method (S10) according to an embodiment of the present disclosure may include extracting the candidate node (S200). In this operation (S200), the first server 100 may request and receive the data from the second server 200. In this operation (S200), the first server 100 may extract the candidate node from the data received from the second server 200.

The value chain extraction method (S10) according to an embodiment of the present disclosure may include extracting an input factor group (S300). In this operation (S300), the first server 100 may request and receive the data on the candidate node from the third server 300. In this operation (S300), the first server 100 may extract the input factor group from the data received from the third server 300.

The value chain extraction method (S10) according to an embodiment of the present disclosure may include extracting relevance data of the candidate node from the input factor group (S400). In this operation (S400), the first server 100 may extract the relevance data using the modeling or the like.

The value chain extraction method (S10) according to an embodiment of the present disclosure may include extracting the sub-node from the relevance data of the candidate node (S500). In this operation (S500), the first server 100 may extract the sub-node from the candidate node based on the relevance data.

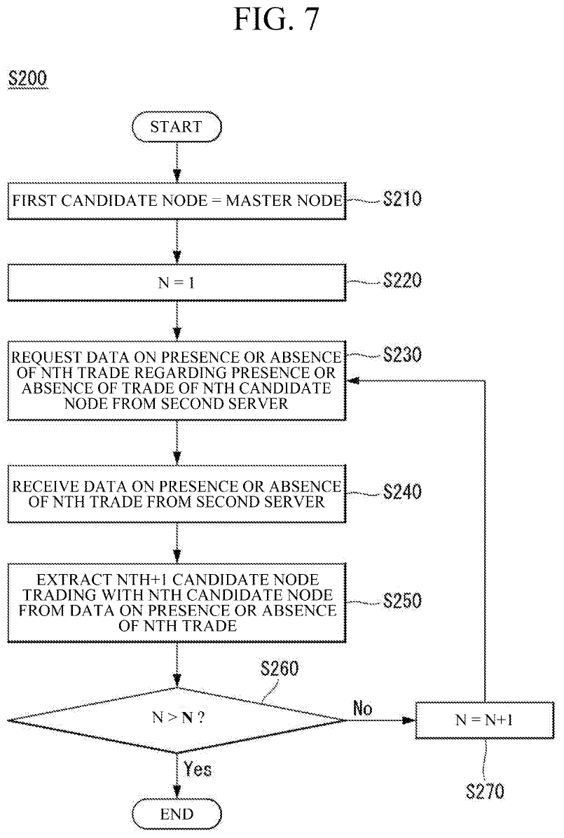

Referring to FIG. 7, the extracting of the candidate node (S200) according to an embodiment of the present disclosure may include setting a first candidate node as the master node (S210). There may be a plurality of candidate nodes. For example, the candidate nodes may include from the first candidate node to an Nth+1 candidate node. Here, N is a natural number. N may indicate an order. The natural number n may be variable. The natural number n may be a coefficient. The natural number N may be the order.

The extracting of the candidate node (S200) according to an embodiment of the present disclosure may include setting the natural number n to 1 (S220).

The extracting of the candidate node (S200) according to an embodiment of the present disclosure may include requesting data on the presence or absence of an nth trade from the second server by the first server (S230). The data on the presence or absence of the nth trade may include information on the presence or absence of a trade of an nth candidate node.

The extracting of the candidate node (S200) according to an embodiment of the present disclosure may include receiving the data on the presence or absence of the nth trade from the second server 200 by the first server 100 (S240). The data on the presence or absence of the nth trade may include information on a trade partner trading with the nth candidate node.

The extracting of the candidate node (S200) according to an embodiment of the present disclosure may include extracting the nth+1 candidate node trading with the nth candidate node from the data on the presence or absence of the nth trade by the first server 100 (S250). In this operation (S250), the nth+1 candidate node may be the trade partner trading with the nth candidate node.

The extracting of the candidate node (S200) according to an embodiment of the present disclosure may include comparing n with N (S260). In a case where n is greater than N in this operation (S260), the extracting of the candidate node (S200) may end.

The extracting of the candidate node (S200) according to an embodiment of the present disclosure may include adding 1 to n (S270). In a case where n is not greater than N in the previous operation (S260), n may be increased by 1 and the requesting of the data on the presence or absence of the nth trade (S230) from the second server may be entered.

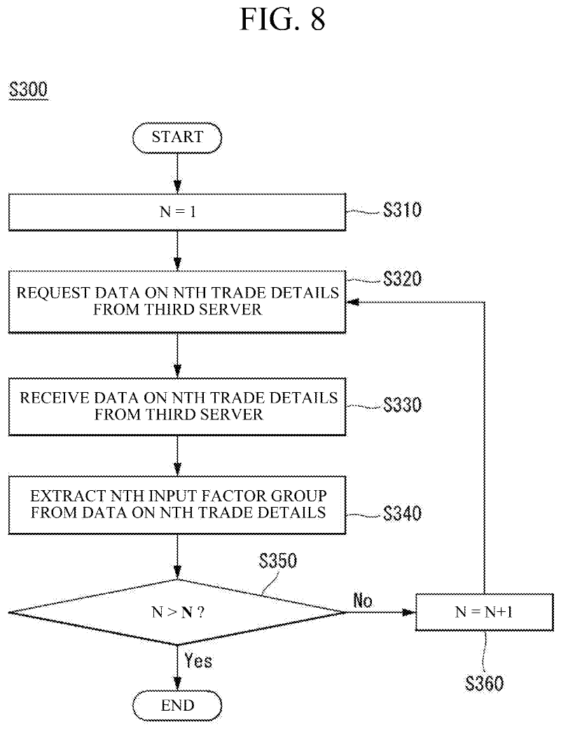

Referring to FIG. 8, the extracting of the input factor group (S300) according to an embodiment of the present disclosure may include setting the natural number n to 1 (S310).

The extracting of the input factor group (S300) according to an embodiment of the present disclosure may include requesting data on nth trade details from the third server 300 (S320). The data on the nth trade details may include information on trade details between the nth candidate node and the nth+1 candidate node.

The extracting of the input factor group (S300) according to an embodiment of the present disclosure may include receiving the data on the nth trade details from the third server 300 (S330). In this operation (S330), the first server 100 may receive the data on the nth trade details from the third server 300. The data on the nth trade details may be, for example, a tax invoice.

The extracting of the input factor group (S300) according to an embodiment of the present disclosure may include extracting an nth input factor group from the data on the nth trade details (S340). In this operation (S340), the first server 100 may extract the nth input factor group from the data on the nth trade details. The nth input factor group may include at least one of trade frequency, trade amount, trade cycle, sales amount, regional distance, trade dependency rate, monthly trade amount and item synchronization index.

The extracting of the input factor group (S300) according to an embodiment of the present disclosure may include comparing n with N (S350). In this operation (S350), the first server 100 may compare n with N. In a case where n is greater than N, the extracting of the input factor group (S300) may end. In a case where n is not greater than N, a next operation (S360) may be entered.

The extracting of the input factor group (S300) according to an embodiment of the present disclosure may include increasing n by 1 (S360). In a case where n is increased by 1, the requesting and the receiving of the data on the nth trade details (S320, S330) may be entered.

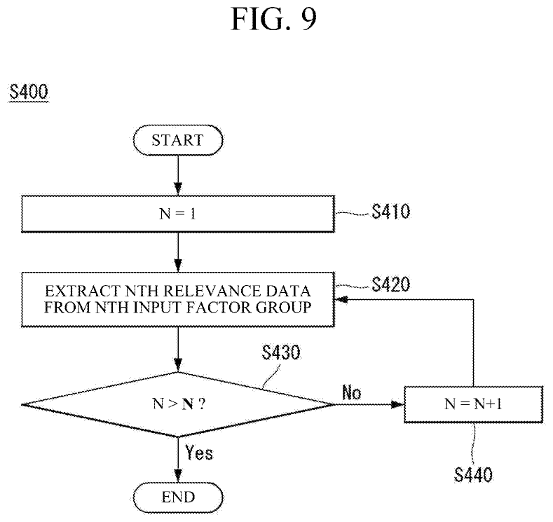

Referring to FIG. 9, the extracting of the relevance data (S400) according to an embodiment of the present disclosure may include setting the natural number n to 1 (S410).

The extracting of the relevance data (S400) according to an embodiment of the present disclosure may include extracting nth relevance data from the nth input factor group (S420). The nth relevance data may indicate a degree of relevance between the nth candidate node and the nth+1 candidate node. The nth relevance data may include a plurality of factors.

The extracting of the relevance data (S400) according to an embodiment of the present disclosure may include comparing n with N (S430). In this operation (S430), the first server 100 may compare n with N. In a case where n is greater than N in this operation (S430), the extracting of the relevance data (S400) may end.

The extracting of the relevance data (S400) according to an embodiment of the present disclosure may include increasing n by 1 (S440). In a case where n is increased by 1, the extracting of the nth relevance data (S420) may be entered.

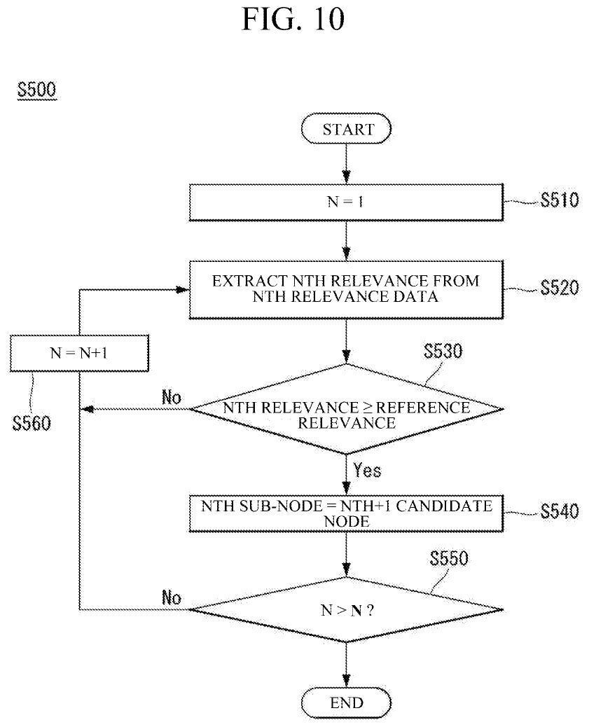

Referring to FIG. 10, the extracting of the sub-node (S500) according to an embodiment of the present disclosure may include setting n to 1 (S510).

The extracting of the sub-node (S500) according to an embodiment of the present disclosure may include extracting nth relevance from the nth relevance data (S520). In a case where the nth relevance data includes one factor, the nth relevance may be the same as the nth relevance data. In a case where the nth relevance data includes a plurality of factors, the nth relevance may be a linear combination of the plurality of factors included in the nth relevance data.

The extracting of the sub-node (S500) according to an embodiment of the present disclosure may include comparing the extracted nth relevance with reference relevance (S530). In a case where the nth relevance is smaller than the reference relevance, n may be increased by 1 and the extracting of the nth relevance (S520) may be entered. In a case where the nth relevance is equal to or greater than the reference relevance, a next operation (S540) may be entered.

The extracting of the sub-node (S500) according to an embodiment of the present disclosure may include setting an nth sub-node as the nth+1 candidate node (S540).

The extracting of the sub-node (S500) according to an embodiment of the present disclosure may include comparing n with N (S550). In a case where n is greater than N in this operation (S550), the extracting of the sub-node (S500) may end. In a case where n is not greater than N in this operation (S550), a next operation (S560) may be entered.

The extracting of the sub-node (S500) according to an embodiment of the present disclosure may include increasing n by 1 (S560). After this operation (S560), the extracting of the nth relevance (S520) may be entered.

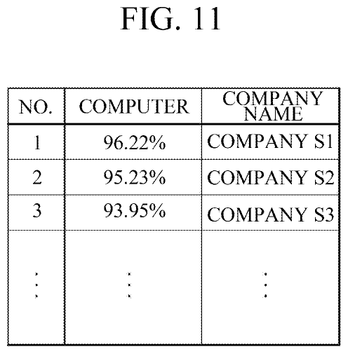

FIG. 11 is a diagram showing a list in which sub-nodes derived by a value chain extraction method according to an embodiment of the present disclosure are listed based on relevance.

Referring to FIG. 11, company S1 may be a sub-node having relevance of 96.22%, which makes company S1 the most relevant to the master node. Company S2 and company S3 may be highly relevant to the master node in sequence. The list in FIG. 11 may be referred to as the value chain company list.

The list of FIG. 11 may be provided to the terminal 400 shown in FIG. 5. The list of FIG. 11 may inform a user of the entity (company) having financial relevance to the master node, and thereby the user may obtain information on which company to watch carefully based on its relevance to the master node.

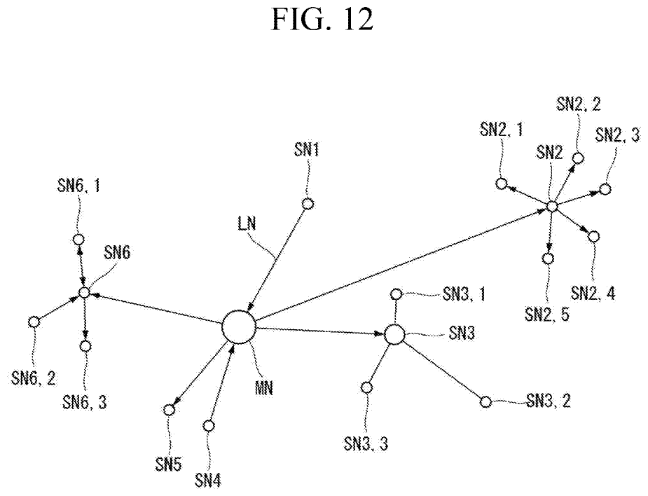

FIG. 12 is a diagram illustrating a graph visualizing a correlation between sub-nodes (SN1, SN2, SN3, SN4, SN5, SN6 and the like) and a master node (MN) derived by a value chain extraction method according to an embodiment of the present disclosure.

Referring to FIG. 12, ‘SNx’ may refer to a primary x sub-node, and ‘SNx,y’ may refer to a secondary y sub-node connected to the primary x sub-node.

The ‘node’ may be a concept of collectively referring to the master node and the sub-node. Lines between the nodes may provide information between the nodes. For example, thickness of the line between the nodes may be greater as relevance between the nodes is greater. For example, an arrow indicated by the line between the nodes may indicate a delivery direction. For example, a distance of the line between the nodes may indicate a geographical distance between the nodes.

The node may have a size and a color. For example, a size of the node may be larger as sales of the node are larger. A darker red color node may indicate a company with the more profits, and a darker blue color node may indicate a company with the more deficits.

A graph shown in FIG. 12 may be a screen displayed on the terminal 400 shown in FIG. 5. Although not shown in the drawing, in a case where a touch input is applied to the node, financial information on the node may be displayed on the screen of the terminal 400.

Some or other embodiments of the present disclosure described above are not mutually exclusive or distinct from each other. In some or other embodiments of the present disclosure described above, their respective configurations or functions may be used jointly or combined with each other.

The above-mentioned detailed description is to be interpreted as being illustrative rather than being restrictive in all aspects. The scope of the present disclosure should be determined by a rational interpretation of the appended claims, and all changes within the equivalent scope of the present disclosure are included in the scope of the present disclosure.

1. A value chain extraction device comprising:
a communication unit transmitting and receiving data on the presence or absence of a trade with an external second server and transmitting and receiving data on trade details with an external third server; and
a controller electrically connected to the communication unit and extracting a value chain company list from the data on the presence or absence of the trade and the data on the trade details,
wherein the communication unit transmits the value chain company list to an external terminal in a case where the controller extracts the value chain company list.

2. The value chain extraction device of claim 1, wherein the controller requests the data on the presence or absence of the trade relevant to a master node from the second server in a case where the communication unit receives a request to extract a value chain based on the master node from the terminal.

3. The value chain extraction device of claim 2, wherein the controller extracts a candidate node relevant to the master node in a case where the communication unit receives the data on the presence or absence of the trade from the second server.

4. The value chain extraction device of claim 3, wherein the controller requests the data on the trade details of the candidate node to the third server, and receives the data on the trade details of the candidate node from the third server to extract an input factor group relevant to the candidate node.

5. The value chain extraction device of claim 4, wherein the controller extracts relevance data of the candidate node from the extracted input factor group and extracts a sub-node from the candidate node based on the relevance data to form the value chain company list.

6. A value chain extraction method using a value chain extraction device including a communication unit and a controller, the value chain extraction method comprising:
receiving a request to extract a value chain based on a master node from an external terminal;
extracting a candidate node relevant to the master node by the controller in a case where the communication unit receives data on the presence or absence of a trade of the master node from an external second server;
extracting an input factor group relevant to the candidate node by the controller in a case where the communication unit receives data on trade details of the candidate node from an external third server;
extracting relevance data of the candidate node from the input factor group of the candidate node by the controller; and
extracting a sub-node from the candidate node based on the relevance data of the candidate node by the controller.

7. The value chain extraction method of claim 6, wherein the extracting of the candidate node includes:
setting a first candidate node as the master node;
setting a coefficient n which is a natural number to 1;
requesting data on the presence or absence of an nth trade including information on the presence or absence of a trade of an nth candidate node from the second server through the communication unit by the controller;
receiving the data on the presence or absence of the nth trade from the second server by the communication unit;
extracting an nth+1 candidate node trading with the nth candidate node from the data on the presence or absence of the nth trade by the controller;
comparing the coefficient n with an order N by the controller; and
adding 1 to the coefficient n by the controller.

8. The value chain extraction method of claim 7, wherein the extracting of the input factor group includes:
setting the coefficient n which is the natural number to 1;
requesting data on nth trade details regarding trade details between the nth candidate node and the nth+1 candidate node from the third server through the communication unit by the controller;
receiving the data on the nth trade details from the third server by the communication unit;
extracting an nth input factor group from the data on the nth trade details by the controller;
comparing the coefficient n with the order N by the controller; and
adding 1 to the coefficient n by the controller.

9. The value chain extraction method of claim 8, wherein the extracting of the relevance data includes:
setting the coefficient n to 1 by the controller;
extracting nth relevance data, which is a degree of relevance between the nth candidate node and the nth+1 candidate node, from the nth input factor group by the controller;
comparing the coefficient n with the order N by the controller; and
adding 1 to the coefficient n by the controller.

10. The value chain extraction method of claim 9, wherein the extracting of the sub-node includes:
setting the coefficient n to 1;
extracting nth relevance from the nth relevance data;
comparing the nth relevance with reference relevance;
setting an nth sub-node as the nth+1 candidate node in a case where the nth relevance is equal to or greater than the reference relevance;
comparing the coefficient n with the order N; and
adding 1 to the coefficient n in a case where the coefficient n is not greater than the order N.
